(19) United States
(12) Patent Application Publication
(10) Pub. No.: US 2021/0367794 A1
(43) Pub. Date: Nov. 25, 2021

(54) DEVICE PROVISIONING SYSTEM

(71) Applicant: Cryptotronix, LLC, Fort Collins, CO (US)

(72) Inventor: Joshua Datko, Fort Collins, CO (US)

(21) Appl. No.: 16/880,586

(22) Filed: May 21, 2020

(51) Int. Cl. H04L 9/32; H04L 9/08; H04L 29/06; G06F 21/86; G06F 21/33

(52) U.S. Cl. CPC H04L 9/3263; H04L 9/0825; G06F 21/33; H04L 9/0877; G06F 21/86; H04L 63/0823

(57) ABSTRACT

Disclosed is an embodiment of a device provisioning system used for securely provisioning a device-to-be-provisioned with a unique identifier, such as a digital certificate. The device provisioning system uses a field programmable gate array that has been programmed to use encryption techniques in accordance in accordance with a public key infrastructure process to generate and issue a digital certificate.

### BACKGROUND

Device provisioning is a process through which an electronic device receives a unique identifier, such as a digital certificate, using cryptographic methods. An application of device provisioning is in authenticating electronic devices, such as embedded devices, that are part of an Internet of Things (IoT) network.

### SUMMARY

A device provisioning system used to provision a device-to-be-provisioned with a digital certificate, comprising: a provisioning controller comprising: a field programmable gate array programmed using encryption techniques so that said field programmable gate array can implement and use a public key infrastructure process, and generate and issue said digital certificate in accordance with said public key infrastructure process.

A method of creating a digital certificate using a device provisioning system comprising: creating a public key infrastructure process using a field programmable gate array; generating said digital certificate using said field programmable gate array in accordance with said public key infrastructure process; issuing said digital certificate using said field programmable gate array in according with said public key infrastructure process.

A method of developing a provisioning plan for a device provisioning system comprising: connecting said device-provisioning-system to a computer, running an application programming interface on said computer; establishing a connection from said application programming interface to said device-provisioning-system, where information provided to said application programming interface is sent to said device-provisioning-system; creating a public key infrastructure process using a field programmable gate array; providing a total number of devices-to-be-provisioned to said application programming interface.

A method of executing a provisioning plan for a device provisioning system comprising: connecting said device provisioning system to a device-to-be-provisioned; generating said digital certificate on said device provisioning system using a field programmable gate array; issuing said digital certificate on said device provisioning system using said field programmable gate array; transferring said digital certificate from said device provisioning system directly to said device-to-be-provisioned using a provisioning port.

### BRIEF DESCRIPTION OF THE DRAWINGS

FIG. 1 is a block diagram of an embodiment illustrating a device provisioning system and a device-to-be-provisioned.

FIG. 2 is a schematic block diagram of an embodiment of a provisioning controller.

FIG. 3 is a block diagram of an embodiment of a circuit board.

FIG. 4 is a block diagram of an embodiment of a carrier board.

FIG. 5 is a block diagram of an embodiment of a token and the two types of token chips.

FIG. 6 is a block diagram of the three subsystems of an FPGA and the components that interact with the FPGA.

FIG. 7 is a flow diagram of an embodiment of a start-up sequence of a device provisioning system.

FIG. 8 is a block diagram of an embodiment of the hardware used in a first-time initialization of a device provisioning system using a developer token.

FIG. 9 is a flow diagram of an embodiment of the steps for completing a first-time initialization of the device provisioning system using a developer token.

FIG. 10 is a block diagram of an embodiment of the hardware used in developing a provisioning plan for a device provisioning system using a USB-Serial connection.

FIG. 11 is a block diagram of an embodiment of the hardware used in developing a provisioning plan for a device provisioning system using an Ethernet connection.

FIG. 12 is a flow diagram of an embodiment of the steps for developing a provisioning plan for a device provisioning system.

FIG. 13 is a block diagram of an embodiment of the hardware used for executing a provisioning plan for a device provisioning system.

FIG. 14 is a flow diagram of an embodiment of the steps for executing a provisioning plan for a device provisioning system.

### DETAILED DESCRIPTION OF THE EMBODIMENTS

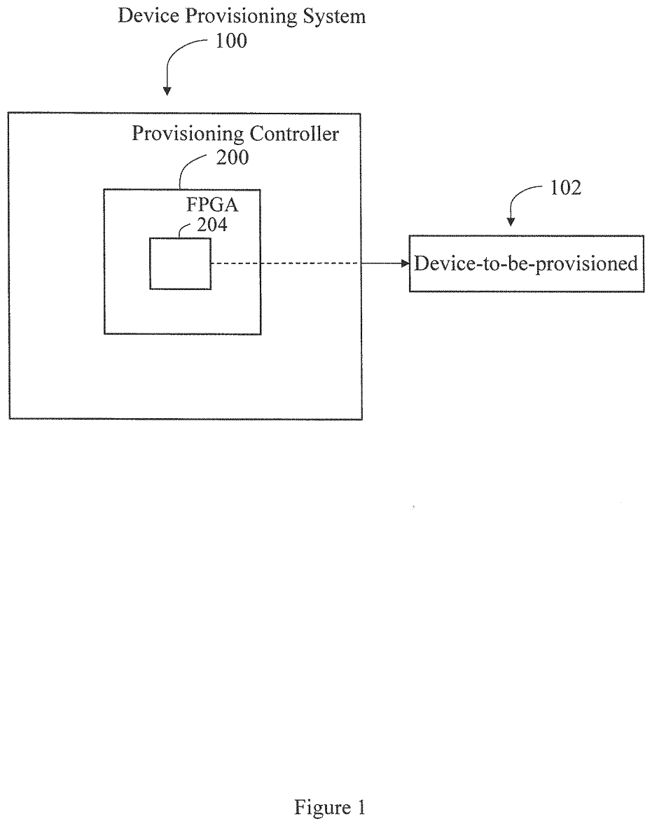

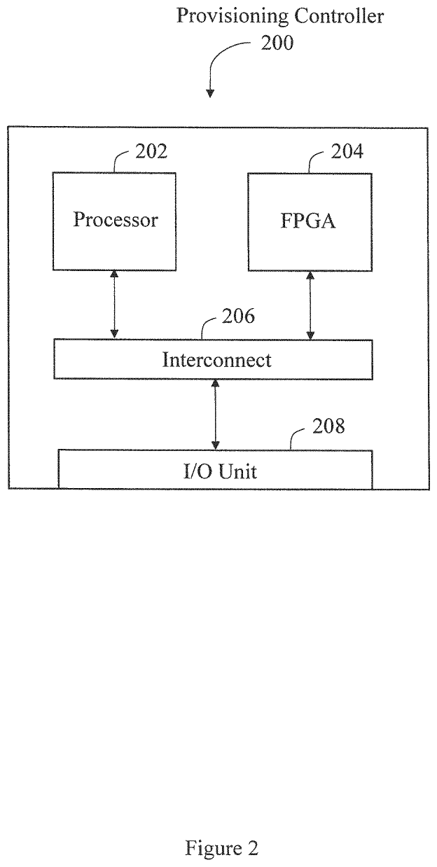

FIG. 1 is a block diagram of an embodiment illustrating a device provisioning system 100 and a device-to-be-provisioned 102. FIG. 1 also shows a major subsystem of device provisioning system 100, provisioning controller 200 (FIG. 2), as well as a major subsystem of provisioning controller 200, field programmable gate array (FPGA) 204. Device provisioning system 100 uses FPGA 204 of provisioning controller 200 to provision device-to-be-provisioned 102 with a unique identifier such as a digital certificate. A digital certificate is a credential that binds identity information to a cryptographic key that can be stored on an electronic device, which is created using a public key infrastructure (PKI) process.

PKI is a combination software, hardware, encryption, and services that enable an individual or organization to protect the security of their data and communications over the Internet. PKI integrates digital certificates, public key cryptography, and certification authorities into one complete network security architecture. PKI uses digital certificates to enable device-to-device or device-to-server identity authentication. A common standard for formatting digital certificates is called the X.509 standard, which is used in many applications, such as in the secure browsing of the Internet and in device authentication. X.509 digital certificates are an accepted standard in the technology industry for validating and verifying the authenticity of an electronic device.

Digital certificates are the foundation of a network's Internet of Things (IoT) security, protecting its data, authenticating its devices, and creating trust for everyone interacting in the network. IoT is a network of electronic devices, commonly consisting of embedded devices, that can interact with each other and other Internet-enabled systems to share and process data. Examples of devices used in an IoT network are smart TVs, smart refrigerators, and smart watches. In an IoT network, an electronic device can contain a digital certificate, such as an X.509 digital certificate, in order to certify the device's authenticity.

To generate, issue, and transfer a digital certificate to an electronic device, an individual or organization can use a Software as a Service (SaaS) solution. A SaaS solution requires an individual or organization to connect an electronic device to the cloud using the Internet, through which the electronic device is provisioned with a digital certificate. If an individual or organization wants to provision a large number of electronic devices with a digital certificate, as is common for many IoT applications, using a SaaS solution would be inefficient, because a remote call to a cloud-based SaaS solution using an Internet connection to provision one electronic device at a time is a slow process and is therefore not efficient for high volume manufacturing, where a manufacturer desires to provision many electronic devices as quickly and efficiently as possible.

Another method of device provisioning is using a hardware security module (HSM). An HSM is a physical computing device that performs cryptographic operations such as generating a digital certificate, and can be used as part of the device provisioning process. However, in order to issue a digital certificate, a certification authority (CA), which is another part of a PKI process, must be used. A CA is a trusted entity that certifies and issues digital certificates. An HSM is not a CA and therefore cannot certify and issue digital certificates. Additionally, an HSM is an expensive device, and its biggest cost is in operations, such as installing, configuring, operating, restoring, and retiring. Also, in order to create a complete system that can provision an electronic device with a digital certificate, which includes creating and using a PKI process, an individual or organization would need to develop their own software that would control and oversee the provisioning process, which can be difficult, time consuming, and costly. Furthermore, an HSM does not directly transfer a digital certificate to an electronic device, but rather, a digital certificate is sent from an HSM to another device, such as a computer. Then an adapter, such as a cable or relay, would be needed in order to transfer the digital certificate from a computer to an electronic device. Even though an HSM is a secure device, ultimately, a digital certificate would be transferred to an electronic device using a computer, which presents security issues because a computer may not have the level of security of an HSM.

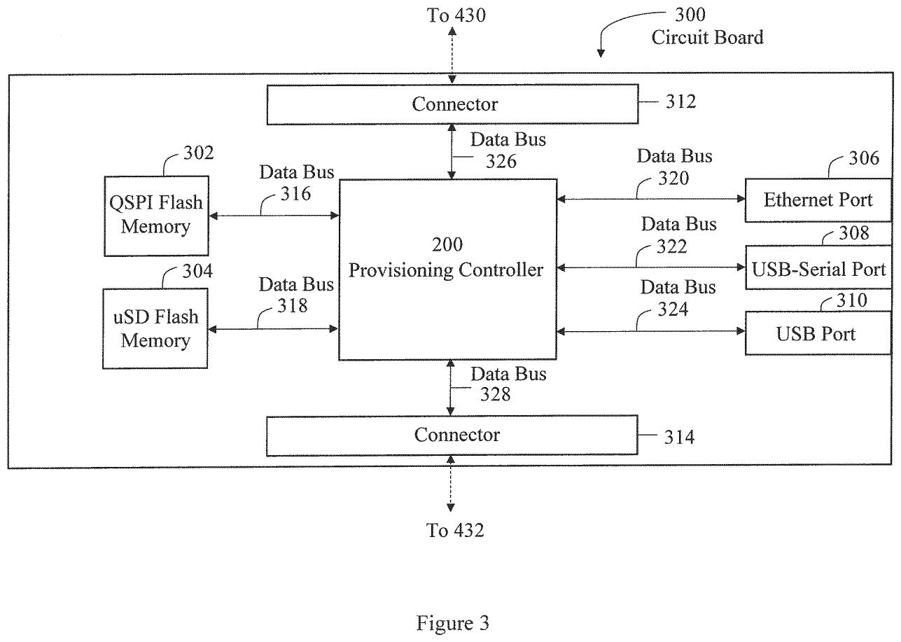

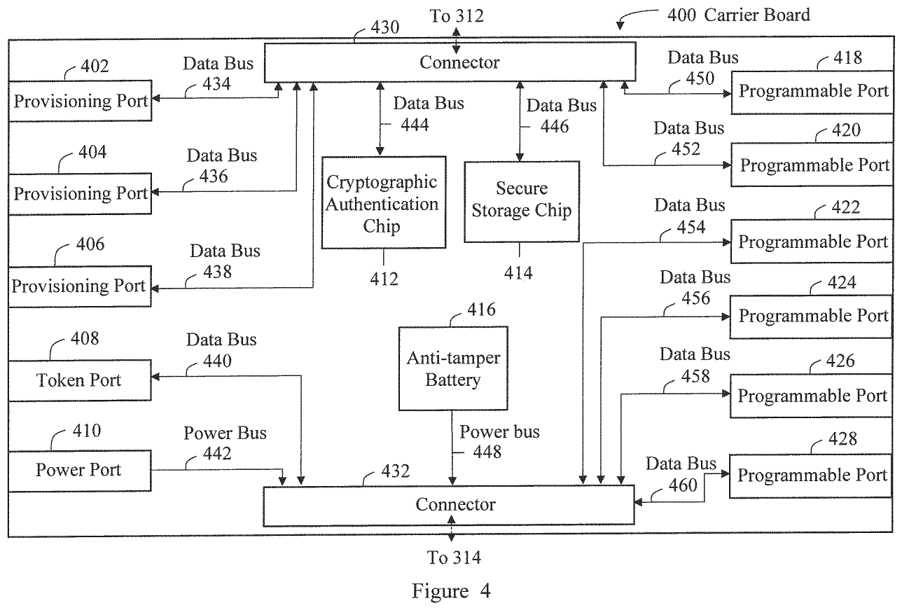

The present application provides a solution for the device provisioning problem, using device provisioning system 100 illustrated in FIG. 1. Device provisioning system 100 provisions device-to-be-provisioned 102 with a digital certificate, such as an X.509 digital certificate. Device provisioning system 100 uses a complete PKI process created in FPGA 204 of provisioning controller 200 in order to generate and issue a digital certificate, and directly transfers the digital certificate to device-to-be-provisioned 102. This results in a more secure, more efficient, faster, and cheaper solution to device provisioning than using a SaaS solution or an HSM solution. Device provisioning system 100 is comprised of three primary elements: first, provisioning controller 200, which generates, issues, and provisions device-to-be-provisioned 102 with a digital certificate using FPGA 204. Provisioning controller 200 is further discussed in FIG. 2. Second, a circuit board 300, which integrates provisioning controller 200 onto a printed circuit board (PCB), thereby allowing provisioning controller 200 access to memory interfaces and external ports to transmit and receive data. Circuit board 300 is further discussed in FIG. 3. Third, a carrier board 400, which circuit board 300 is mounted to, that has additional external ports that can directly connect to device-to-be-provisioned 102, as well as components providing device-provisioning-system 100 with security features and additional functionality. Carrier board 400 is further discussed in FIG. 4.

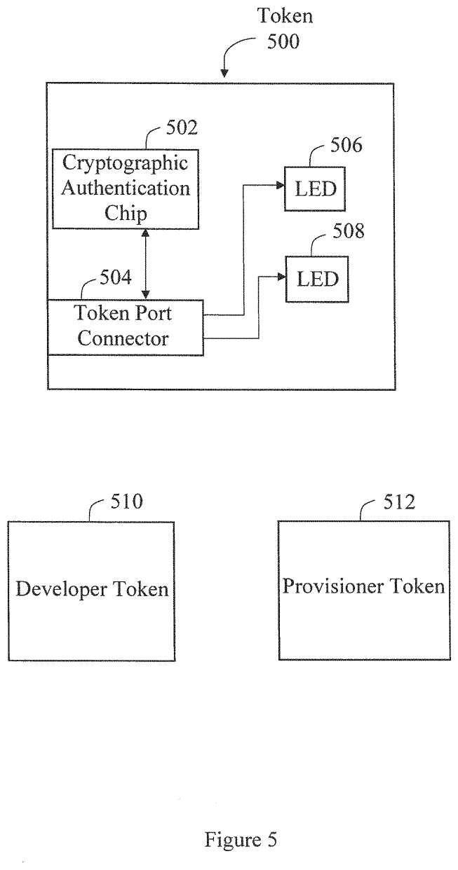

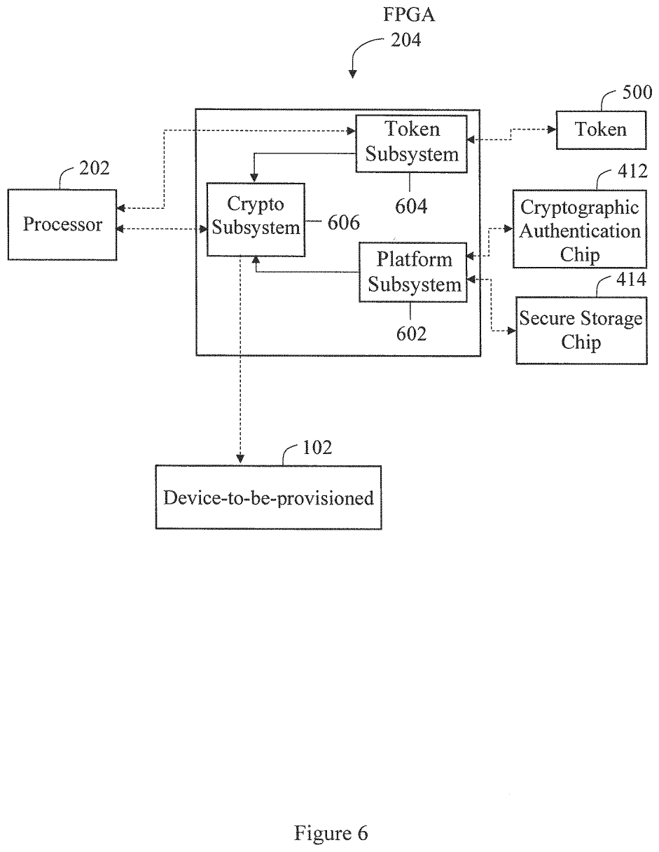

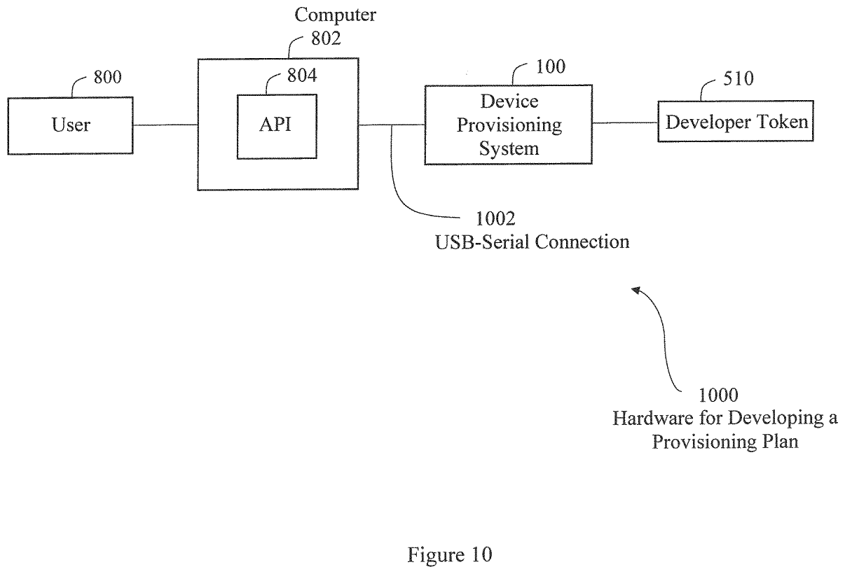

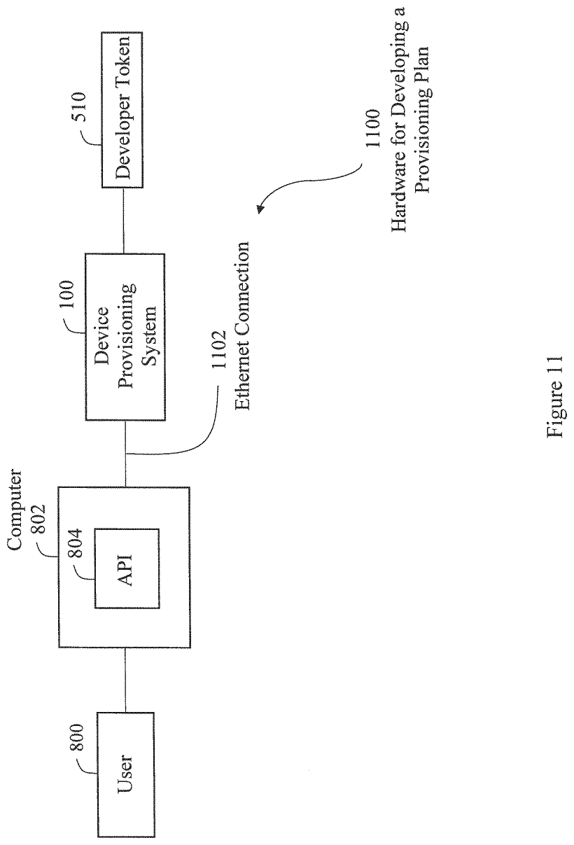

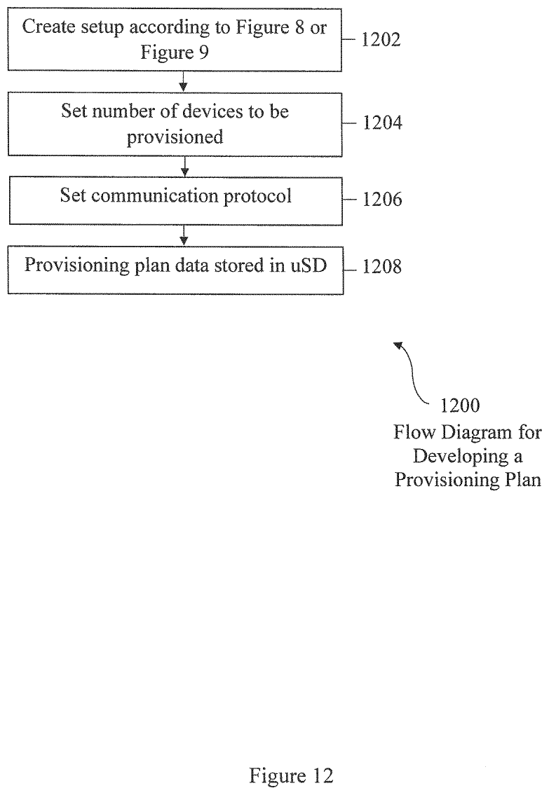

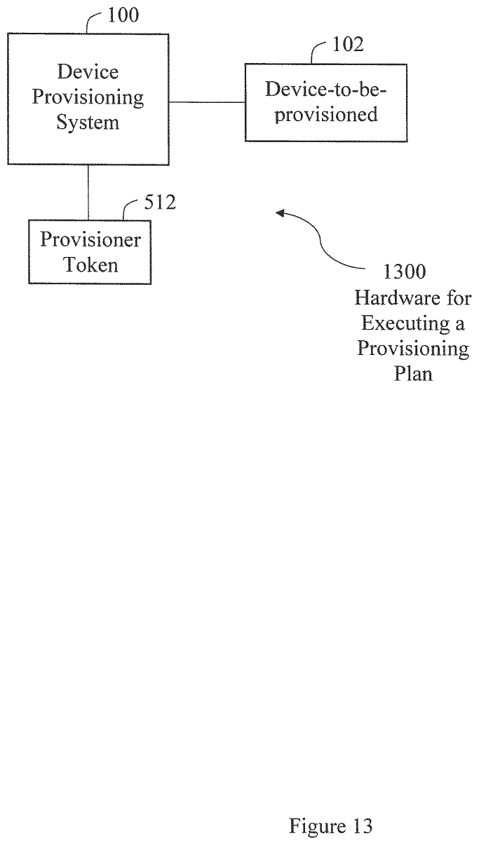

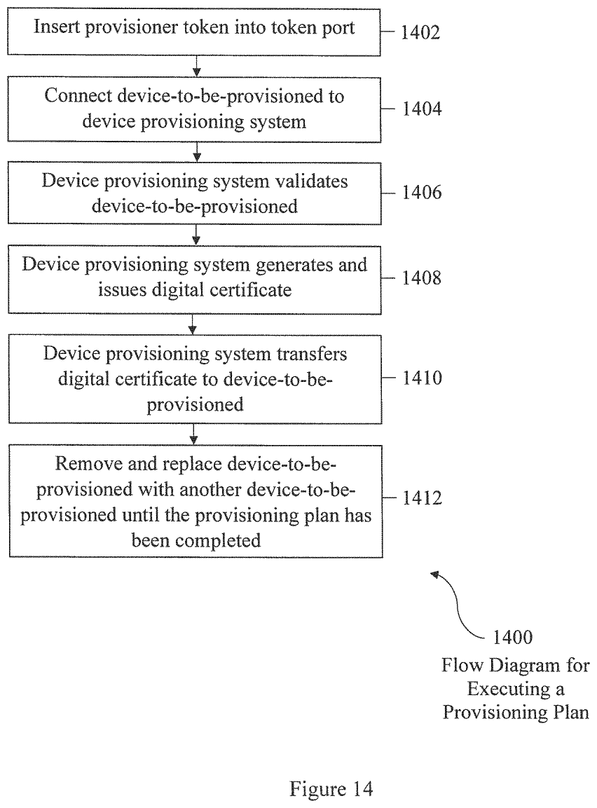

FIG. 2 is schematic a block diagram of an embodiment of a provisioning controller 200. Provisioning controller 200 is an integrated circuit (IC), such as the Xilinx Zynq-7000 system-on-chip (SoC). In general, a SoC integrates components of a computer or electronic system, all on a single substrate or microchip. A SoC, such as the Xilinx Zynq 7000, can be purchased from Xilinx's website (xilinx.com). SoCs are used in a wide variety of applications, such as in embedded systems. Device-provisioning-system 100 is an embedded system that uses provisioning controller 200, which can be a SoC, to generate, issue, and provision device-to-be-provisioned 102 with a digital certificate using FPGA 204. Provisioning controller 200 does not have to be a specific type of integrated circuit, such a SoC, so long as there are at least components analogous to the ones shown in FIG. 2, and can perform the following functions: generating, issuing, and provisioning a digital certificate to a device-to-be-provisioned 102. Provisioning controller 200, as shown in FIG. 2, comprises processor 202, field programmable gate array 204 (FPGA), interconnect 206, and I/O unit 208. Processor 202, such as the ARM-Cortex-A9 CPU, which is a type of processor that is used in the Xilinx Zynq 7000 SoC, performs a variety of functions, including receiving and executing instructions, sending commands, and directing a provisioning plan. Details about developing a provisioning plan are described in FIG. 10, FIG. 11, and FIG. 12. Details about executing a provisioning plan are described in FIG. 13 and FIG. 14. FPGA 204, such as the Arctix-7 FPGA, which is a type of FPGA that is used in the Xilinx Zynq 7000 SoC, performs a variety of functions, including performing cryptographic operations such as creating a PKI process, which is then used to generate and issue digital certificates, as well as performing bitstream and hardware authentication checks, and verifying token 500 authenticity and token 500 role. FPGA 204 can perform the functions of an HSM, such as using cryptographic operations to generate a digital certificate, and can also perform functions that an HSM does not perform, such as creating a complete PKI process. FPGA 204 is discussed in more detail in FIG. 6 and token 500 is discussed in more detail in FIG. 5.

FIG. 2 illustrates an interconnect that is coupled to processor 202 and FPGA 204. Interconnect 206 is an internal data bus, such as the AXI AMBA Interconnect, which is a type of interconnect that is used in the Xilinx Zynq 7000 SoC. Interconnect 206 connects to both processor 202 and FPGA 204. Through interconnect 206, data can be transmitted between processor 202 and FPGA 204. Additionally, interconnect 206 connects to input/output (I/O) unit 208. I/O unit 208 is also an internal data bus, and allows data to enter and exit provisioning controller 200. Data entering and exiting provisioning controller 200 can be in a wide variety of formats, such as USB, UART, I2C, and SPI. I/O unit 208 provides a medium for different types of data to input into provisioning controller 200 and output from provisioning controller 200.

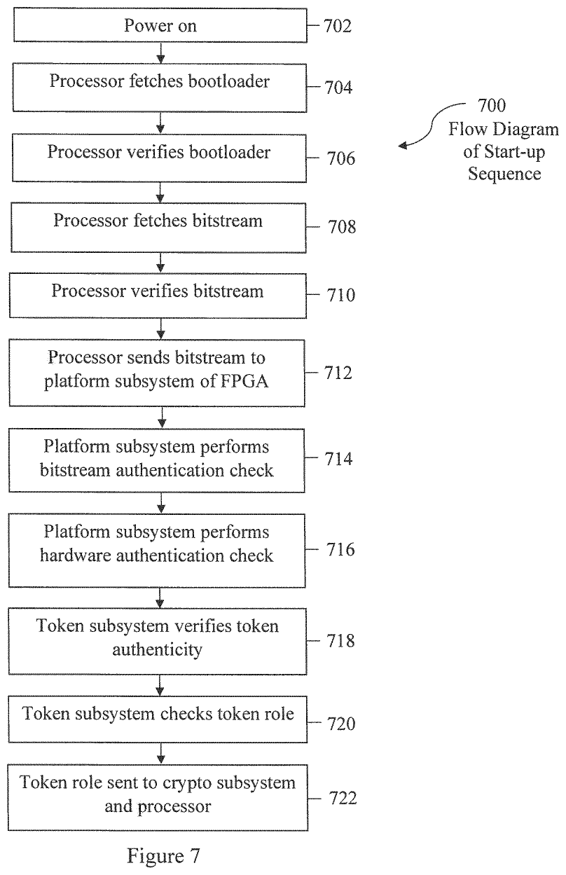

FIG. 3 is a block diagram of an embodiment of a circuit board 300. Circuit board 300 is a printed circuit board (PCB), such as the MicroZed 7000 system-on-module (SoM). In general, a SoM is a PCB that fully integrates a SoC onto a SoM. A SoM is typically developed by a different entity (i.e., MicroZed) from the developer of a SoC (i.e., Xilinx). A SoM, such as the MicroZed 7000, can be purchased from MicroZed's website (microzed.org). In order to integrate a SoC onto a SoM, memory interfaces can be used to house software that a SoC uses to function, as well as to store data. Additionally, a SoM can contain external interfaces that can be used to program a SoC. Circuit board 300 does not have to be a SoM, it is only necessary that circuit board 300 integrates provisioning controller 200 onto a PCB. The circuit board 300 according to FIG. 3 comprises provisioning controller 200, such as the Xilinx Zynq 7000 SoC, a first nonvolatile memory, such as quad serial peripheral interface (QSPI) 302 flash memory, a second nonvolatile memory, such as micro storage drive (uSD) 304 flash memory, Ethernet port 306, USB-Serial port 308, USB port 310, connector 312 and connector 314. QSPI flash memory 302 is a type of nonvolatile flash memory that stores the bootloader and bitstream for device provisioning system 100. A bootloader is a program that runs on processor 202 when device provisioning system 100 is initially powered on. Details regarding a device-provisioning-system 100 start-up sequence are discussed in FIG. 7. A bitstream is a file that contains the programming information for FPGA 204. QSPI flash memory 302 is connected to and communicates with provisioning controller 200 through a data bus 316. uSD flash memory 304 is a type of nonvolatile flash memory that stores data generated by device provisioning system 100, such as data generated during a first-time initialization of device provisioning system 100 and data generated during the development of a provisioning plan. uSD flash memory 304 is connected to and communicates with provisioning controller 200 through a data bus 318.

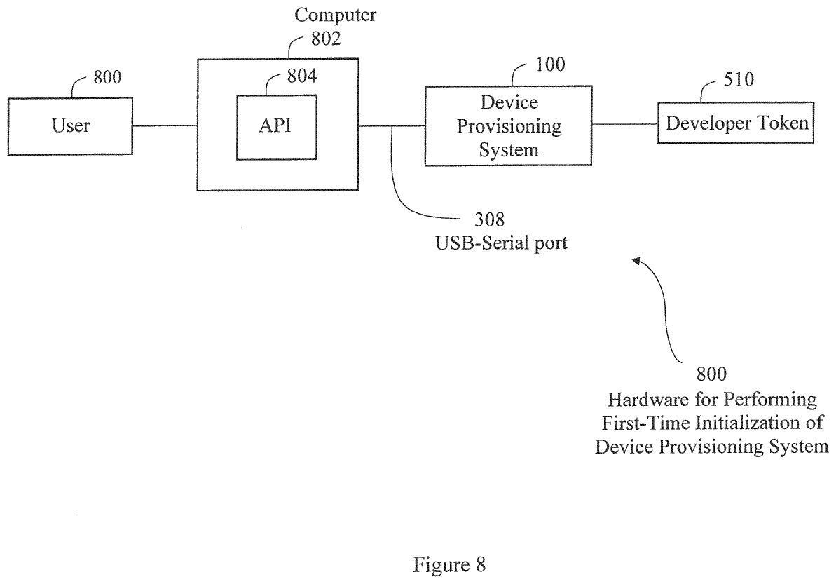

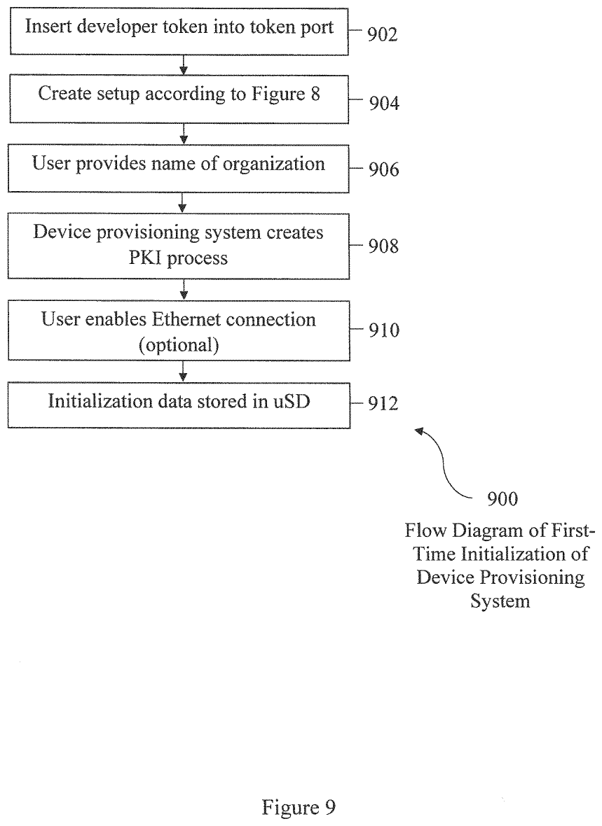

FIG. 3 further illustrates Ethernet port 306, which is an external interface that provides a network connection for device provisioning system 100. Ethernet port 306 is connected to and communicates with provisioning controller 200 through a data bus 320. Ethernet port 306 can also be used to establish a network connection using a computer through which a user can develop a provisioning plan for device-provisioning-system 100. USB-Serial port 308 is an external interface that can be used to establish a local connection to a computer through which a user can develop a provisioning plan for device-provisioning-system 100. Additionally, USB-Serial port 308 is used for a first-time initialization of device-provisioning-system 100, which is shown and discussed in FIG. 8 and FIG. 9. USB-Serial port 308 converts USB formatted data to serially formatted data, such as UART. USB-Serial port 308 is connected to and communicates with provisioning controller 200 through a data bus 322. USB port 310 is an external interface that can be used for integration with USB peripherals. For example, a USB mass storage device (i.e., a USB stick), could be inserted into USB port 310 in order to export data from device-provisioning-system 100 to a USB stick. USB port 310 is connected to and communicates with provisioning controller 200 through a data bus 324. Connector 312 is an external interface that connects to connector 430 on carrier board 400. Data from carrier board 400 is routed from connector 430 on carrier board 400 to connecter 312 on circuit board 300, which is then routed to provisioning controller 200 through a data bus 326 that connects connector 312 to provisioning controller 200. Connector 314 is an external interface that connects to connector 432 (FIG. 4) on carrier board 400. Data from carrier board 400 (FIG. 4) is routed from connector 432 on carrier board 400 to connecter 314 on circuit board 300, which is then routed to provisioning controller 200 through a data bus 328 that connects connector 314 to provisioning controller 200. Details regarding carrier board 400 are further discussed in FIG. 4.

FIG. 4 is a block diagram of an embodiment of a carrier board 400. In general, a carrier board, also known as a base board, is a PCB that another PCB, such as circuit board 300, is mounted to, and can implement additional functionality to a circuit board 300. The carrier board 400, as illustrated in FIG. 4, comprises provisioning ports 402, 404, 406, token port 408, power port 410, cryptographic authentication chip 412, secure storage chip 414, anti-tamper battery 416, programmable ports 418, 420, 422, 424, 426, 428, and connectors 430 and 432. Circuit board 300 (FIG. 3) is mounted to carrier board 400, where connector 312 of circuit board 300 connects to connector 430 of carrier board 400, and connector 314 connects to connector 432. Provisioning ports 402, 404, 406 are external interfaces that support serial communication protocols such as I2C, UART, and SPI. Provisioning ports are used to provide a direct connection between device provisioning system 100 and device-to-be-provisioned 102, through which device provisioning system 100 provisions device-to-be-provisioned 102 with a digital certificate.

Each of the provisioning ports 402, 404, 406, as illustrated in FIG. 4, connect to connector 430 through data buses 434, 436, 438, respectively. Token port 408 is an external interface that acts as a lock to device provisioning system 100, which can only be unlocked by inserting token 500 (FIG. 5) into token port 408. Token port 408 connects to connector 432 through a data bus 440. Cryptographic authentication chip 412 is a secure IC that is used to verify that circuit board 300 has not been removed from carrier board 400 and used on a counterfeit piece of hardware, by performing a cryptographic authentication protocol with FPGA 204, which is discussed in detail in FIG. 6. Cryptographic authentication chip 412 connects to connector 430 through a data bus 444. Secure storage chip 414 is type of nonvolatile memory, such as an EEPROM, that stores pairing information about token 500 (FIG. 5). After token 500 has been inserted into token port 408, data from token 500 can be stored in secure storage chip 414. Secure storage chip 414 connects to connector 430 through a data bus 446. Anti-tamper battery 416 is used as a security feature that prevents removing circuit board 300 from carrier board 400. Anti-tamper battery 416 provides power directly to FPGA 204 through connector 432. Anti-tamper battery 416 is connected to connector 432 by a power bus 448. When circuit board 300 is removed from carrier board 400, anti-tamper battery 416 loses power, which causes FPGA 204 to lose power, which in turn causes specific data on FPGA 204 to be erased, causing FPGA 204 to become inoperable, rendering device provisioning system 100 unusable. Power port 410 is an external interface that powers device provisioning system 100 using 5 Volt DC power. Power port 410 connects to connector 432 through a power bus 442.

Programmable ports 418, 420, 422, 424, 426, 428, illustrated in FIG. 4, are external interfaces that can be used to further customize device provisioning system 100. An electronic device or module can be inserted into any one of programmable ports 418, 420, 422, 424, 426, 428 in order to provide device-provisioning-system 100 with more functionality. For example, a real time clock module can be inserted into any one of programmable ports 418, 420, 422, 424, 426, 428, and be used for time stamping during the execution of a provisioning plan, so that device-provisioning-system 100 can record the time at which device-to-be-provisioned 102 is provisioned with a digital certificate. A real time clock module can also provide clock pulses for rate limiting, i.e., ensuring only a certain number of provisions occur during a period of time while a provisioning plan is being executed. Further, a temperature sensor module can be connected to any one of programmable ports 418, 420, 422, 424, 426, 428, which can measure the temperature of the surrounding environment. Programmable ports 418, 420, 422, 424, 426 can communicate using a serial communication protocol such as I2C, SPI, or UART. Programmable ports 418, 420 connect to connector 430 through data buses 450, 452, respectively. Programmable ports 422, 424, 426, 428 connect to connector 430 through data buses 454, 456, 458, 460, respectively. Although the components of carrier board 400 have been configured to connect to connectors 430 and 432 according to what is shown in FIG. 4, those components could be reconfigured to connect to connectors 430 and 432 in a different configuration.

FIG. 5 is a block diagram of an embodiment of a token 500 and the two types of token chips, a developer token 510 and a provisioner token 512. Token 500 acts as a cryptographic ignition key (CIK). A CIK is a device or electronic key used to unlock a secure mode of cryptographic equipment. In this case, token 500 is the CIK and device provisioning system 100 is the cryptographic equipment. Without token 500, device-provisioning-system 100 is rendered unusable. Token 500 comprises cryptographic authentication chip 502, token port connector 504, and LEDs 506, 508. Cryptographic authentication chip 502 contains authentication data that FPGA 204 (FIG. 2) uses to verify the authenticity of token 500 by performing a cryptographic authentication protocol. An example of a cryptographic authentication protocol is the “challenge/response” protocol, where one party (FPGA 204) presents a challenge that another party (cryptographic authentication chip 502) must respond. If cryptographic authentication chip 502 does not correctly respond to FPGA 204 challenge, FPGA 204 is disabled, rendering device-provisioning-system 100 unusable. Cryptographic authentication chip 502 communicates with FPGA 204 using I2C communication protocol. Additionally, cryptographic authentication chip 502 contains data regarding the role of token 500, meaning whether token 500 is a developer token 510 or provisioner token 512. When developer token 510 is inserted into token port 408, features relating to developing a provisioning plan for device-provisioning-system 100 are enabled. When provisioner token 512 is inserted into token port 408, features relating to executing a provisioning plan are enabled. Token port connector 504 connects to token port 408 on carrier board 400, which establishes a connection between token 500 and device-provisioning-system 100. LEDs 506, 508 can be customized to flash a unique pattern, providing a way visually authenticate token 500.

FIG. 6 is a block diagram of the three subsystems of FPGA 204 (FIG. 2) and the components that interact with the FPGA 204. FPGA 204 comprises platform subsystem 602, token subsystem 604, and crypto subsystem 606. Platform subsystem 602 is responsible for performing bitstream and hardware authentication checks, and communicates with secure storage chip 414 and cryptographic authentication chip 412. Within the bitstream is authentication data that platform subsystem 602 detects to verify the bitstream's authenticity. Cryptographic authentication chip 412 contains authentication data that platform subsystem 602 uses to verify the authenticity of cryptographic authentication chip 412 by performing a cryptographic authentication protocol. An example of a cryptographic authentication protocol is the “challenge/response” protocol, where one party (platform subsystem 602) presents a challenge that another party (cryptographic authentication chip 412) must respond. If cryptographic authentication chip 412 does not correctly respond to platform subsystem 602 challenge, FPGA 204 is disabled, rendering device provisioning system 100 unusable. This prevents circuit board 300 from being removed from carrier board 400, and using board 300 on a counterfeit piece of hardware. Platform subsystem 602 communicates with cryptographic authentication chip 412 using I2C communication protocol. In order to retrieve data on secure storage chip 414, platform subsystem 602 presents a unique password that secure storage chip 414 is pre-programmed to expect to receive, and if the password is correct, platform subsystem 602 can access data on secure storage chip 414. Platform subsystem 602 enables token subsystem 604 after bitstream and hardware authentication checks have been successfully performed. Token subsystem 604 authenticates token 500 by using a cryptographic authentication protocol, such as the “challenge/response” protocol discussed in FIG. 5, and then determines whether token 500 is a developer token 510 or provisioner token 512. After token 500 has been authenticated and token role is determined, the token role (i.e., whether a developer token 510 or provisioner token 512 has been inserted into token port 408) is sent to crypto subsystem 606 and processor 302. Developer token 510 enables features related to the development of a provisioning plan and provisioner token 512 enables features related to the execution of a provisioning plan. Crypto subsystem 606 is where cryptographic operations are performed, which includes creating a PKI process, and generating and issuing digital certificates. Unlike an HSM, which can perform cryptographic operations, such as generating a digital certificate, crypto subsystem 606 creates a complete PKI process, which includes a certification authority, that allows a digital certificate to not only be generated, but also to be certified and issued by a certification authority. Using crypto subsystem 606 of FPGA 204 to create a PKI process, which then is used to generate and issue digital certificates, has three main benefits: first, FPGA 204 is a highly secure IC, and creating a PKI process entirely in FPGA 204 minimizes security risks that are inherently present when a PKI process is created using multiple devices, such as in the HSM solution. Second, using one component, such as FPGA 204, to create a PKI process that is used to generate and issue digital certificates is a simple, elegant solution that makes the process of device provisioning faster and more efficient. Using multiple components or devices to create a PKI process in order to generate and issue digital certificates creates additional complexity, and adds additional time to complete a provisioning process when compared to using one component (FPGA 204) to perform all the previously stated functions. Third, using FPGA 204 is a cheaper solution to device provisioning, because using one component, as opposed to using many components, to create a PKI process to generate and issue a digital certificate is less expensive and more cost effective.

After a digital certificate has been generated and issued by crypto subsystem 606, the digital certificate is directly transferred to device-to-be-provisioned 102 through one of the provisioning ports 402, 404, 406. Directly provisioning a device-to-be-provisioned 102 with a digital certificate is a simpler and more secure solution for device provisioning, as opposed to an HSM solution, because an HSM does not directly transfer a digital certificate to an electronic device. Directly provisioning a device-to-be-provisioned 102 is also faster and more efficient than using a SaaS solution, which requires wireless communication between two entities, namely, an electronic device and the cloud-based SaaS solution being used. An electronic device, such as device-to-be-provisioned 102, would need to wirelessly connect to a cloud-based SaaS solution, make a request to receive a digital certificate, then receive the digital certificate after the cloud-based SaaS solution has created the digital certificate. This process, as opposed to the process utilized by device provisioning system 100, is slow and inefficient, especially in a high volume manufacturing environment.

FIG. 7 is a flow diagram of an embodiment of a start-up sequence of a device-provisioning-system 100. Device-provisioning-system 100 is powered on when 5V DC power is provided to power port 410 at step 702. Processor 202 fetches bootloader from QSPI 302 at step 704. Processor 202 verifies bootloader at step 706. Processor 202 fetches bitstream from QSPI flash memory 302 at step 708. Processor 202 verifies the bitstream at step 710. Processor 202 sends bitstream to platform subsystem 602 of FPGA 204 at step 712. Platform subsystem 602 of FPGA 204 performs a bitstream authentication check at step 714. Platform subsystem 602 of FPGA 204 performs a hardware authentication check at step 716. Token subsystem 604 of FPGA 204 verifies token 500 authenticity at step 718. Token subsystem 604 of FPGA 204 checks token 500 role at step 720. Token role (i.e. whether a developer token or provisioner token 512) is sent to crypto subsystem 606 and processor 202 at step 720. After the previously mentioned steps are successfully performed, device-provisioning-system 100 is enabled according to which type of token 500 has been inserted. When developer token 510 is inserted into token port 408, a user can perform a first-time-initialization of device provisioning system 100, as well as develop a provisioning plan. When provisioner token 512 is inserted into token port 408, a user can execute a provisioning plan.

FIG. 8 is a block diagram of an embodiment of the hardware used in a first-time initialization of device provisioning system 100. Performing a first-time initialization requires device-provisioning-system 100 to be connected to a computer 802 through USB-Serial port 308 of circuit board 300 (FIG. 3). Through an application programming interface (API) 804 running on computer 802, a user 800 sends commands to initialize device provisioning system 100. An API 804 is a computing interface that contains a set of functions and procedures that user 800 uses to initialize device-provisioning-system 100. Although not explicitly shown, user 800 can connect to, and interface with, computer 802 using commonly known devices such as a keyboard and mouse. API 804 has already been developed and created before user 800 interacts with API 804, and provides a simple way to interact with and program device provisioning system 100. Additionally, developer token 510 must be inserted into token port 408. First-time initialization of device provisioning system 100 can occur after the start-up sequence of device provisioning system 100 has been successfully performed.

FIG. 9 is a flow diagram of an embodiment of the steps for completing a first-time initialization of the device-provisioning-system 100 using a developer token 510. Developer token 510 is inserted into token port 408 at step 902. User 800 creates a setup according to FIG. 8 at step 904. User 800 provides the name of user's 800 organization through API 804 at step 906. Device provisioning system 100 will be pre-programmed to expect an organization name given by user 800. Device-provisioning-system 100 creates a PKI process in the crypto subsystem 606 of FPGA 204 based on the organization name given by user 800 at step 908. The PKI process is eventually used to generate and issue a digital certificate. Optionally, user 800 can enable network connectivity using Ethernet at step 910, which can be used when developing a provisioning plan. Data relating to the first-time initialization of device provisioning system 100 is stored in uSD flash memory 304 at step 912.

FIG. 10 shows a block diagram of an embodiment of the hardware used in developing a provisioning plan for a device provisioning system 100 using a USB-Serial connection 1002. Developing a provisioning plan requires device provisioning system 100 to be connected to computer 802 through USB-Serial connection 1002 that is connected to USB-Serial port 308. Through API 804 running on computer 802, user 800 sends commands to device-provisioning-system 100 to develop a provisioning plan. Additionally, developer token 510 must be inserted into token port 408. Developing a provisioning plan is further discussed in FIG. 12.

FIG. 11 shows a block diagram of an embodiment of the hardware used in developing a provisioning plan for a device provisioning system 100 using an Ethernet connection 1102. Developing a provisioning plan requires device provisioning system 100 to be connected to computer 802 through Ethernet connection 1102 that is connected to Ethernet port 306. Through API 804 running on computer 802, user 800 sends commands to device-provisioning-system 100 to develop a provisioning plan. Additionally, developer token 510 must be inserted into token port 408.

FIG. 12 is a flow diagram of an embodiment of the steps of developing a provisioning plan for a device provisioning system 100. First-time initialization of device provisioning system 100 must be performed prior to developing a provisioning plan. After user 800 creates a setup according to FIG. 10 or FIG. 11 at step 1202, user sets a total number of devices-to-be-provisioned 102 to be provisioned at step 1204, and sets the communication protocol (i.e. I2C, UART, SPI) at step 1206, through which device provisioning system 100 transfers a digital certificate to device-to-be-provisioned 102. Data generated from the development of a provisioning plan is stored in uSD 304 at step 1208. In order to check whether provisioning plan works, a user 800 can remove developer token 510, insert a provisioner token 512, and test the provisioning plan. Executing a provisioning plan is shown and discussed in FIG. 13 and FIG. 14.

FIG. 13 is a block diagram of an embodiment of the hardware used for executing a provisioning plan for device provisioning system 100. In order to execute a provisioning plan, provisioner token 512 must be inserted into token port 408. Device provisioning system 100 is connected to device-to-be-provisioned 102 through one of the provisioning ports 402, 404, 406. Device provisioning system 100 will recognize device-to-be-provisioned 102 has been connected through one of the provisioning ports 402, 404, 406, and provision device-to-be-provisioned 102 with a digital certificate. Up to three devices-to-provisioned 102 can be inserted the provisioning ports 402, 404, 406 during the execution of a provisioning plan.

FIG. 14 is a flow diagram 1400 of an embodiment of the steps for executing a provisioning plan for a device provisioning system 100. Provisioner token 512 is inserted into token port 408 at step 1402. Device-to-be-provisioned 102 is connected to device provisioning system 100 through one of provisioner ports 402, 404, 406 at step 1404. Device provisioning system 100 validates device-to-be-provisioned 102 at step 1406. Device provisioning system 100 generates and issues a digital certificate at step 1408. Device provisioning system 100 transfers the digital certificate to device-to-be-provisioned 102 at step 1410. If there are multiple devices-to-be-provisioned 102 that need a digital certificate, a device-to-be-provisioned 102, after receiving a digital certificate, is removed and replaced with another device-to-be-provisioned 102, which then receives a digital certificate at step 1412. This process occurs until the provisioning plan has been completed, i.e., all devices-to-be-provisioned 102 have received a digital certificate according to the provisioning plan that has been developed.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A device provisioning system used to provision a device-to-be-provisioned with a digital certificate, comprising:
a provisioning controller comprising:
a field programmable gate array programmed to use encryption techniques in accordance with a public key infrastructure process to generate and issue said digital certificate, said field programmable gate array being further programmed to generate a public key and a private key for said public key infrastructure process;
a processor that receives and stores data from a user for developing a provisioning plan, said provisioning plan comprising instructions for the public key infrastructure process to generate and issue said digital certificate, and directs execution of said provisioning plan;
at least one provisioning port, coupled to said provisioning controller, through which said digital certificate is transferred from said field programmable gate array of said device provisioning system to said device-to-be-provisioned;

2. The device provisioning system of claim 1 further comprising:
a first nonvolatile memory coupled to said provisioning controller that contains instructions said provisioning controller uses to boot-up and operate;
a second nonvolatile memory coupled to said provisioning controller that stores data generated from said provisioning controller;
an Ethernet port coupled to said provisioning controller that provides a connection through which device provisioning system can connect to a network;
a local connection port coupled to said provisioning controller that provides a connection through which device provisioning system can connect to a computer and transmit and receive data to and from said computer;
a power port used to provide power to said device provisioning system.

3. The device provisioning system of claim 1 wherein said provisioning controller further comprises:
an interconnect coupled to said processor and said field programmable gate array, through which data can be transferred between said processor and said field programmable gate array;
an input/output unit coupled to said interconnect, said input/output unit being used to transfer data into and out of said provisioning controller.

4. The device provisioning system of claim 2 wherein said first nonvolatile memory is a quad serial peripheral flash memory chip.

5. The device provisioning system of claim 2 wherein said second nonvolatile memory is a micro storage drive flash memory chip.

6. The device provisioning system of claim 1 wherein said local connection port is a USB-Serial port.

7. The device provisioning system of claim 1 wherein said provisioning port is configured to transmit data using a UART communication protocol.

8. The device provisioning system of claim 1 wherein said provisioning port is configured to transmit data using a SPI communication protocol.

9. The device provisioning system of claim 1 wherein said provisioning port is configured to transmit data using an I2C communication protocol.

10. The device provisioning system of claim 1 further comprising a USB port being used for integration with USB peripherals.

11. The device provisioning system of claim 1 further comprising:
a token port coupled to said provisioning controller;
a token that unlocks said device provisioning system when inserted into said token port.

12. The device provisioning system of claim 11 wherein said token further comprises:
a developer token being inserted into said token port when developing a provisioning plan for said device provisioning system;
a provisioner token being inserted into said token port when executing a provisioning plan for said device provisioning system;

13. The device provisioning system of claim 1 further comprising a cryptographic authentication chip coupled to said provisioning controller, used to verify authenticity of said device provisioning system using a cryptographic authentication protocol.

14. The device provisioning system of claim 1 further comprising an anti-tamper battery coupled to said provisioning controller that, if removed from said device provisioning system, renders device provisioning system inoperable.

15. The device provisioning system of claim 1 further comprising at least one programmable port coupled to said provisioning controller, said programmable port being used to implement additional functionality to said device provisioning system by connecting an electronic module to said programmable port.

16. The device provisioning system of claim 14 wherein said electronic module is a real time clock module.

17. The device provisioning system of claim 14 wherein said electronic module is a temperature sensor module.

18. The device provisioning system of claim 1 wherein said digital certificate is an X.509 digital certificate.

19. The device provisioning system according to claim 1, further comprising:
a first printed circuit board that comprises a provisioning controller, a first nonvolatile memory coupled to said provisioning controller, a second nonvolatile memory coupled to said provisioning controller, an Ethernet port coupled to said provisioning controller, a local connection port coupled to said provisioning controller, and a first connector coupled to said provisioning controller;
a second printed circuit board that comprises a provisioning port, a token port, a power port, a cryptographic authentication chip, an anti-tamper battery, a programmable port, and a second connector coupled to said provisioning port, said token port, said power port, said cryptographic authentication chip, said anti-tamper battery, said programmable port; said second connector being connected to said first connector so that said provisioning port, said token port, said power port, said cryptographic authentication chip, said anti-tamper battery, said programmable port become coupled to said provisioning controller.

20. A method of creating a digital certificate using a device provisioning system comprising:
creating a public key infrastructure process on said device provisioning system using a field programmable gate array;
generating a public key and a private key for said public key infrastructure process using said field programmable gate array;
generating said digital certificate on said device provisioning system using said field programmable gate array;
issuing said digital certificate on said device provisioning system using said field programmable gate array.

21. A method of developing a provisioning plan for a device provisioning system comprising:
connecting said device-provisioning-system to a computer;
running an application programming interface on said computer;
establishing a connection from said application programming interface to said device-provisioning-system, wherein information provided to said application programming interface is sent to said device-provisioning-system;
creating a public key infrastructure process using a field programmable gate array;
generating a public and a private key for said public key infrastructure process using said field programmable gate array;
providing a total number of devices-to-be-provisioned to said application programming interface.

22. A method of developing a provisioning plan for said device provisioning system according to claim 21 further comprising providing an organization name to said application programming interface.

23. A method of developing a provisioning plan for said device provisioning system according to claim 21 further comprising providing, to said application programming interface, a communication protocol that formats how data is sent from said device provisioning system to said device-to-be-provisioned.

24. A method of developing a provisioning plan for said device provisioning system according to claim 21 wherein said method of connecting said device provisioning-system to said computer is accomplished using a USB-Serial port.

25. A method of developing a provisioning plan for said device provisioning system according to claim 21 wherein said method of connecting said device provisioning system to said computer is accomplished using an Ethernet port.

26. A method of developing a provisioning plan for said device provisioning system accord to claim 21 further comprising inserting a developer token into a token port in order to unlock use of said device provisioning system.

27. A method of developing a provisioning plan for said device provisioning system according to claim 21 further comprising storing data related to said provisioning plan in a nonvolatile flash memory.

28. A method of executing a provisioning plan for a device provisioning system comprising:
connecting said device provisioning system to a device-to-be-provisioned;
creating a public key infrastructure process using a field programmable gate array;
generating a public key and a private key for said public key infrastructure process using said field programmable gate array;
generating a digital certificate on said device provisioning system using said field programmable gate array;
issuing said digital certificate on said device provisioning system using said field programmable gate array;
transferring said digital certificate from said device provisioning system directly to said device-to-be-provisioned using a provisioning port.

29. A method of executing a provisioning plan for said device provisioning system according to claim 28 further comprising inserting a provisioner token into a token port in order to unlock use of said device provisioning system.

30. A method of executing a provisioning plan for said device provisioning system according to claim 28 further comprising:
disconnecting said device-to-be-provisioned from said device provisioning system after said device-to-be-provisioned receives said digital certificate;
connecting said device provisioning system to a second device-to-be-provisioned;
generating a second digital certificate on said device provisioning system using said field programmable gate array;
issuing said second digital certificate on said device provisioning system using said field programmable gate array;
transferring said second digital certificate from said device provisioning system to said second device-to-be-provisioned using said provisioning port;
repeating the previous steps until the total number of devices-to-be-provisioned have been provisioned, according to said provisioning plan.
